(19) United States
(12) Patent Application Publication
(10) Pub. No.: US 2002/0003682 A1
(43) Pub. Date: Jan. 10, 2002

(54) MAGNETIC DISC UNIT

(76) Inventor: TSUYOSHI KAKUNO, FUKUSHIMA-KEN (JP)

Correspondence Address: BRINKS HOFER GILSON & LIONE, P.O. BOX 10395, CHICAGO, IL, 60610, US

(21) Appl. No.: 09/324,539

(22) Filed: Jun. 2, 1999

(30) Foreign Application Priority Data
Jun. 10, 1998 (JP) 10-162161

(51) Int. Cl. G11B 5/37

(52) U.S. Cl. 360/246.2; 360/246.8

(57) ABSTRACT

In a head portion 13 disposed at a side 1, rails 13a and are formed projectingly and a head gap G16 is formed in the rail 13a located on an inner side. Likewise, in a head portion 15 disposed at a side 0, rails 15a and 15b are formed projectingly in an opposed relation to the rails 13b and 13a, respectively, and a head gap G17 is formed in the rail 15a located on an outer side. A point 16a of abutment of the head gap G16 with a magnetic disc D and a point 17a of abutment of the head gap G17 with the magnetic disc are projected in an alternate manner beyond a center S in the thickness direction the magnetic disc, whereby the head gaps G16, G17 and the magnetic disc D can be kept in satisfactory contact with each other.

### BACKGROUND OF THE INVENTION

1. Field of the Invention

The present invention relates to a magnetic disc unit wherein magnetic heads are brought into sliding contact with a magnetic disc to read and write data. Particularly, the invention is concerned with a magnetic disc unit wherein magnetic heads and a magnetic disc are kept in good touch with each other.

2. Description of the Related Art

FIG. 5 is an enlarged sectional view showing heads used in a conventional magnetic disc unit. For example, in the magnetic disc unit there is used a medium comprising a hard case and a flexible magnetic disc D received therein.

When the hard case is inserted into the disc unit, a shutter provided in the hard case opens, a surface of the magnetic disc D is exposed from a window formed in the hard case, and head portions 25 and 30 hold the magnetic disc D from above and below. The head portion 25 located on a side 1 is integrally formed with rail portions 21a and 21b at both ends of inner and outer sides of the magnetic disc D, the rail portions 21a and 21b being each projected in a tangential direction of rotation of the magnetic disc. In the rail portion 21 are embedded a pair of head cores 22, and a head gap G22 serving as a bond portion of the head cores 22 is exposed at the tip of the rail portion 21a.

The head portion 30, like the head portion 25, is also formed with rail portions 31a and 31b, head cores 32 are embedded on the rail portion 31b side with respect to the magnetic disc D, and a head gap G32 formed by the head cores 32 is exposed to the surface of the rail portion 31b.

The magnetic disc D used has data zones formed respectively on both sides of the disc, and access is made thereto through the two head gaps G22 and G32 to write or read data.

In the conventional magnetic disc unit, however, the head touch to the magnetic disc D is not good and the head gaps may float up from the disc surface at the time of writing or reading data. Thus, a writing or reading error has been very likely to occur.

In the conventional magnetic disc unit 40 shown in FIG. 5, in an effort to avoid such an inconvenience and for improving the touch of the head portions 25 and 30, especially the head gaps G22 and G32, relative to the magnetic disc D, the head portions 25 and 30 as a whole are each disposed at a position shifted by a distance H downward (or upward) from a center S in the thickness direction of the magnetic disc D so that the magnetic disc D somewhat deflects downward when held by both head portions 25 and 30 from above and below. Consequently, even with a strain developed in the magnetic disc D, both head gaps G22 and G32 can positively come into abutment with the disc surfaces.

However, in such a conventional magnetic disc unit, indicated at 40, it is required that priority be given to either the upper head gap G22 or the lower head gap G32, to adjust a vertical position of each of the head portions 25 and 30, and it has so far been difficult to attain a good head touch of both head gaps G22 and G32.

By increasing, for example, a downward shift distance of the head gaps G22 and G32 from the center S in the thickness direction of the magnetic disc D, there can be attained a good head touch. However, if the head gaps G22 and G32 are projected too much, there arises a problem that magnetic layers formed on the disc surfaces are damaged (media wear) with a frictional force induced by sliding contact of the head portions 25 and 30 including the head gaps G22 and G32 with the disc D. Also in the event the pressure (load pressure) for pressing the head portions 25 and 30 against the magnetic disc D is set too high, the disc D is likely to be damaged by the resulting frictional force.

Further, if the head gaps G22 and G32 are projected largely, say, downward with respect to the center S in the thickness direction of the magnetic disc D, the disc is deformed largely at its portion sandwiched between the head portions 25 and 30, which may rather result in unstable contact between the head gaps G22, G32 and the magnetic disc.

### SUMMARY OF THE INVENTION

The present invention has been accomplished for solving the above-mentioned problems and it is an object of the invention to provide a magnetic disc unit capable of improving the head touch of upper and lower head gaps with a magnetic disc.

According to the present invention there is provided a magnetic disc unit including a flexible magnetic disc, heads disposed in an opposed relation to both sides of the magnetic disc, and head gaps formed in the heads, wherein when the magnetic disc is held between both head gaps, a point of abutment of one head gap with the magnetic disc and a point of abutment of the other head gap with the magnetic disc project in an alternate manner beyond a thickness center of the magnetic disc.

In this case it is preferable that the heads be each provided with two rails projecting in a rotating direction of the magnetic disc and that the associated head gap be formed in one of the rails.

With the above means, both head gaps positioned respectively above and below the magnetic disc are prevented from floating up with respect to the disc and can be surely contacted with the disc. Consequently, the occurrence of a data read error or a data write error at the time of access to data is prevented.

In the above means, given that the spacing between the foregoing abutment points in the disc thickness direction is A, it is desirable to satisfy the relation of 0<A≦0.1 mm.

If the spacing A is within the above range, it will be possible to attain a good head touch. If the spacing A exceeds 0.1 mm, the magnetic disc will be deformed in S shape within the short distance between both head gaps, with consequent deterioration of head touch. Besides, there will occur a phenomenon (media wear) such that the magnetic disc is rubbed against both-end corner portions of the heads, resulting in the film on the disc being scraped off.

Preferably, the center between the abutment points in the disc thickness direction is within the range of ±0.3 mm with respect to a reference position of the magnetic disc.

In this case, given that an ideal vertical position of the magnetic disc is 0 (a reference position), if the center between the abutment points is displaced upward from the reference position, the displacement is allowed up to +0.3 mm, while if it is displaced downward from the reference position, the displacement is allowed up to −0.3 mm. Within the above range of ±0.3 mm, there is attained a good head touch.

Thus, since the displacements can be allowed in the range of ±0.3 mm, a good head touch is ensured even in the case of a large tolerance of components used in the magnetic disc and even in the case of a large medium assembling tolerance.

Preferably, a load pressure for pressing the magnetic disc through the heads is in the range from 3 gf to 25 gf.

If the load pressure is within the above range, it will be possible to obtain a good head touch without causing media wear. If the load pressure is lower than 3 gf, it will be impossible to obtain a satisfactory head touch, and a load pressure exceeding 25 gf will result in media wear.

According to the magnetic disc unit constructed as above, against curling of the magnetic disc or against disc strain adjustment at the time of sticking the disc to a hub, it is no longer necessary to increase the load pressure forcibly for the improvement of head touch. Thus, it is possible to solve the problem of data being unable to be read or written correctly and the problem of media wear occurrence.

### BRIEF DESCRIPTION OF THE DRAWINGS

FIG. 1 is a perspective view showing an appearance of a magnetic disc unit embodying the present invention;

FIG. 2 is a plan view showing an internal structure of the magnetic disc unit;

FIG. 3 is an enlarged sectional view showing an example of a layout relation between magnetic heads and a magnetic disc in reading and writing of data;

FIG. 4 is an enlarged sectional view showing another example of a layout relation between magnetic heads and a magnetic disc in reading and writing of data; and

FIG. 5 is an enlarged sectional view showing heads used in a conventional magnetic disc unit.

### DETAILED DESCRIPTION OF A PREFERRED EMBODIMENT

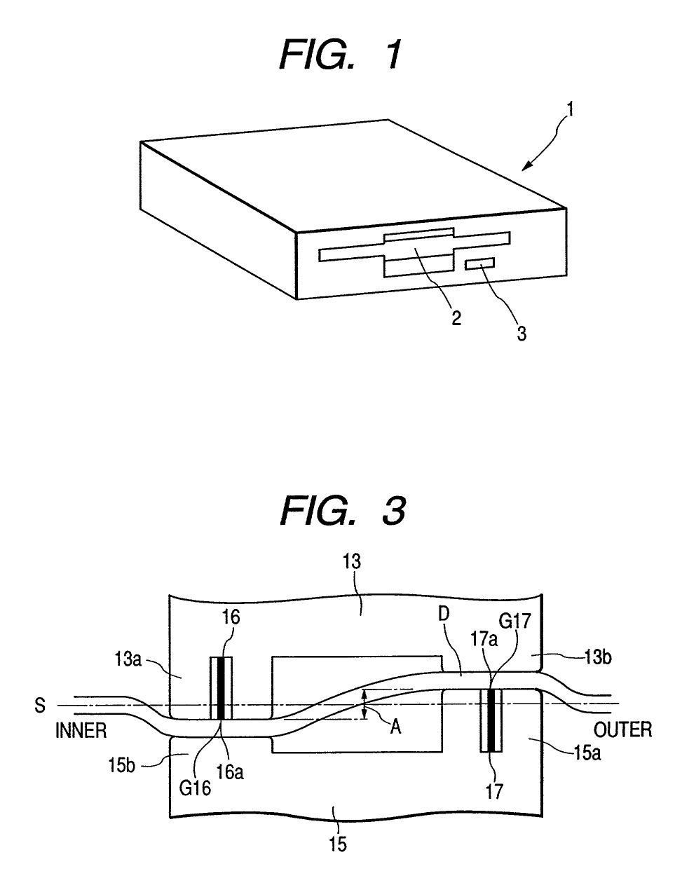

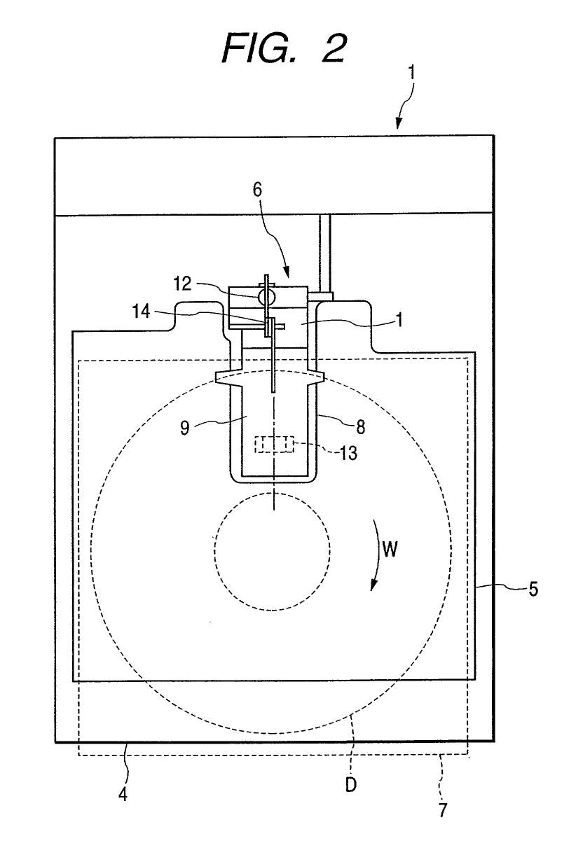

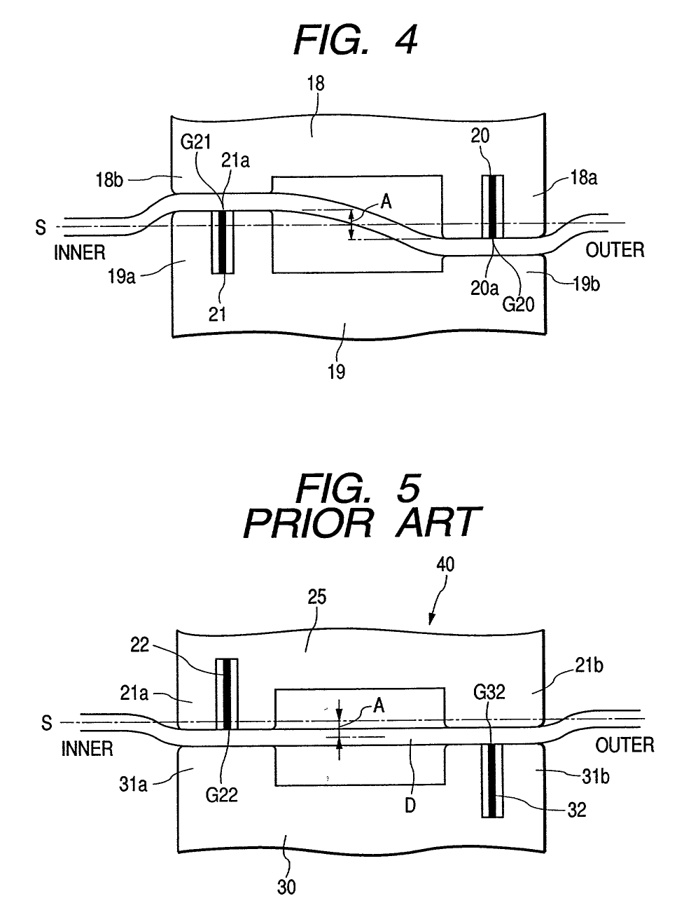

A magnetic disc unit embodying the present invention will be described in detail hereinunder with reference to FIGS. 1 to 4, of which FIG. 1 is a perspective view showing an appearance of the magnetic disc unit, FIG. 2 is a plan view showing an internal structure of the magnetic disc unit, and FIGS. 3 and 4 are enlarged sectional views each showing a positional relation between head portions and a magnetic disc in reading and writing of data.

As shown in FIG. 1, the magnetic disc unit, indicated at 1, is constituted by a box-shaped housing. An insertion port 2 for a disc case 7 and an ejection button 3 for taking out the disc case 7 are formed in the front side of the housing. The magnetic disc unit 1 is applicable not only to a floppy disc drive (a low capacity FDD) of a low capacity but also to a floppy disc drive using a floppy disc of a larger memory capacity than the low capacity FDD.

According to an internal mechanism of the magnetic disc unit 1, a holder 5 for receiving therein the disc case 7 which contains a magnetic disc D is provided on a chassis 4. In the upper surface of the holder 5 is formed a cutout portion 8 in a longitudinal direction (magnetic disc inserting/ejecting direction), and an arm 9 is disposed so as to be movable longitudinally within the cutout portion 8. The longitudinal movement of the arm 9 is effected by means of a drive unit (not shown). A head portion 13 is disposed on the magnetic disc D side of the arm 9 and it moves radially of the disc together with the arm 9. The arm 9 is connected at its base end portion to a plate spring 11, which in turn is fixed at a base end thereof to a carriage with a screw 12. The head portion 13 is made movable vertically by the action of the plate spring 11. Further, a torsion coil spring 14 is mounted on the arm 9 to urge the arm toward the magnetic disc D at all times.

In the magnetic disc unit 1 constructed as above, when the disc case 7 is inserted from the insertion port 2 and moves up to a predetermined position within the holder 5, the holder 5 moves down and a center hub of the magnetic disc D housed in the disc case 7 is loaded onto a turntable. At this time, the lower surface of the magnetic disc D comes into contact with a head portion 15 (see FIG. 3) which is disposed on a side 0 opposite to the head portion 13 with respect to the magnetic disc. Next, as the holder 5 descends, the head portion 13 located on the side 1 moves down to the position of the magnetic disc D while being urged by the torsion coil spring 14 and comes into contact with the upper surface of the disc D. In this way, head gaps formed in both head portions come into contact with the upper and lower surfaces, respectively, of the magnetic disc D. As the magnetic disc D rotates in W direction, the upper and lower head portions 13, 15 slide on the disc surfaces to record or reproduce data.

FIG. 3 shows a state in which a magnetic head 6 having the head portions 13 and 15 reads or writes data while sliding on the magnetic disc D.

As shown in FIG. 3, the head portion 13 is disposed on the side 1 and two rails 13a and 13b are projected from a slider on the side opposed to the magnetic disc D which slider constitutes the head portion 13. The rails 13a and 13b are formed in parallel with each other so that their longitudinal direction coincide with a tangential direction of the magnetic disc D. Further, a pair of head cores 16 are embedded on the rail 13a side (inner side) so that a head gap G16 as a connection of the head cores 16 is exposed from the tip of the rail 13a.

The head portion 15 is disposed on the side 0 and two rails 15a and 15b are projected from a slider on the side opposed to the magnetic disc D which slider constitutes the head portion 15. The rails 15a and 15b are disposed opposedly to the rails 13b and 13a, respectively, which are located on the head portion 13 side, and the rails 15a and 15b are formed in the same direction as in the head portion 13 described above. On the rail 15a side (outer side), head cores 17 are embedded so that a head gap G17 is exposed from the tip of the rail 15a.

In this magnetic headunit, the rails 13a and 15a provided with head gaps G16 and G17 project in an alternate manner beyond the center S in the disc thickness direction, and in their projected positions both rails hold the disc D therebetween. More specifically, in the head portion 13 at the side 1, the surface of the rail 13a projects below the surface of the rail 13b, while in the head portion 15 at the side 0 the surface of the rail 15a projects above the surface of the rail 15b. The difference in height between the surfaces of the rails 13a and 13b and the difference in height between the surfaces of the rails 15a and 15b are the same.

By projecting the rails 13a and 15a in an alternate manner and by projecting the head gaps G16 and G17 in the same manner, the magnetic disc D is pressed into a wavy shape as shown in the figure. While maintaining this state, there is performed reading and writing of data.

In the magnetic disc unit 1 of the present invention, given that the spacing in the thickness direction of the magnetic disc D between a point 16a of abutment of the head gap G16 with the magnetic disc and a point 17a of abutment of the head gap G17 with the magnetic disc is A, it is preferable that the relation of 0<A≦0.1 mm be satisfied (condition 1). As long as the spacing A is within this range, a satisfactory contact between both head gaps G16, G17 and the magnetic disc D is ensured. If the spacing A exceeds 0.1 mm, the magnetic disc D will be deformed in S shape in a short distance and rather a poor contact between the head gaps and the magnetic disc will result. Besides, there will occur a phenomenon (media wear) such that the magnetic disc D is rubbed against the head portions 13 and 15, resulting in the film formed on the disc surface being scraped off.

In this case, the media wear will be more marked in a floppy disc (FD) of a higher capacity than the conventional low-capacity floppy disc (FD) . More particularly, the above medium (magnetic disc) usually comprises a base film and a magnetic layer, and in the conventional low-capacity FD the base film thickness is 75 μm and the coating thickness of the magnetic layer is 1.9 to 2.8 μm, while in the case of a high-capacity FD the base film thickness is 62 μm and the coating thickness of the magnetic layer is 0.1 to 0.4 μm. Thus, the coating thickness of the high-capacity FD is fairly smaller than that of the low-capacity FD. For this reason, the aforesaid media wear is apt ot occur. However, according to the magnetic disc unit 1 of the present invention, it is possible to prevent the occurrence of the media wear for high-capacity media having a thin magnetic layer.

It is preferable that the center between the abutment points 16a and 17a in the disc thickness direction (the center S of the magnetic disc D in FIG. 3) be within the range of ±0.3 mm with respect to the reference position of the magnetic disc D (condition 2).

It is preferable that the load pressure (P) of the head portions 13 and 15 against the magnetic disc D be in the range of 3≦P ≦25 gf (condition 3). If the load pressure P is lower than 3 gf, the head portions 13 and 15 may float from the magnetic disc, which may cause a data write error or read error. If the load pressure P exceeds 25 gf, there will be no further improvement of head touch, but rather the media wear will occur.

The above conditions 1 to 3 may be suitably combined and adjusted to ensure a satisfactory head touch not causing the media wear.

FIG. 4 shows another example of a magnetic head device different from that shown in FIG. 3.

As shown in the same figure, this magnetic head device is provided with head portions 18 and 19, in which head gaps are located at positions different from those in the magnetic head device of FIG. 3.

In the head portion 18 at the side 1, two rails 18a and 18b are formed projectingly on the side opposed to the magnetic disc D. The rails 18a and 18b are formed so that their longitudinal direction coincide with a tangential direction of the magnetic disc D. On the rail 18a side (outer side), head cores 20 are embedded and a head gap G20 is exposed from the tip of the rail 18a.

In the head portion 19 at the side 0, two rails 19a and 19b are formed projectingly on the side opposed to the magnetic disc D so that they are opposed to the rails 18b and 18a, respectively, formed on the head portion 18 side. On the rail 19a side (inner side), head cores 21 are embedded and a head gap G21 is exposed from the tip of the rail 19a.

The foregoing conditions 1 to 3 are also applicable to the magnetic head device shown in FIG. 4. The reference mark A shown in FIG. 4 is assumed to be a spacing in the thickness direction of the magnetic disc D between a point 20a of abutment of the head gap G20 with the magnetic disc D and a point 21a of abutment of the head gap G21 with the magnetic disc D.

By projecting the head gaps G16 and 017 (G20 and G21) in an alternate manner, the magnetic disc D is pressed so as to curve in a wavy shape and there is performed reading and writing of data while maintaining this state.

In the magnetic disc unit 1 of the present invention, flexible magnetic discs D are employable, including conventional low-capacity floppy discs, as well as floppy discs of higher capacities.

What is claimed is:

1. A magnetic disc unit comprising:
a flexible magnetic disc;
heads disposed in an opposed relation to both sides of said magnetic disc; and
head gaps formed in said heads,
wherein when said magnetic disc is held between both said head gaps, a point of abutment of one head gap with the magnetic disc and a point of abutment of the other head gap with the magnetic disc project in an alternate manner beyond a thickness center of the magnetic disc.

2. A magnetic disc unit according to claim 1, wherein said heads are each provided with two rails projecting in a rotating direction of said magnetic disc, and the associated' head gap is formed in one of said rails.

3. A magnetic disc unit according to claim 1, wherein if the spacing between said abutment points in the disc thickness direction is assumed to be A, the spacing A is in the range of 0<A≦0.1 mm.

4. A magnetic disc unit according to claim 1, wherein the center between said abutment points in the disc thickness direction is in the range of ±0.3 mm with respect to a reference position of said magnetic disc.

5. A magnetic disc unit according to claim 1, wherein a load pressure for pressing the magnetic disc through said heads is set at a value in the range from 3 gf to 25 gf.
